(19) United States
(12) Patent Application Publication
(10) Pub. No.: US 2013/0122256 A1
(43) Pub. Date: May 16, 2013

(54) PROTECTIVE MATERIAL

(71) Applicants: Svein Kleiven, Stockholm (SE); Hans Von Holst, Djursholm (SE)

(72) Inventors: Svein Kleiven, Stockholm (SE); Hans Von Holst, Djursholm (SE)

(21) Appl. No.: 13/697,448

(22) PCT Filed: May 12, 2011
(86) PCT No.: PCT/EP11/57730

§ 371 Date: Jan. 28, 2013

Related U.S. Application Data
(60) Provisional application No. 61/395,344, filed on May 12, 2010.
(60) Provisional application No. 61/395,386, filed on May 12, 2010.

(51) Int. Cl. B32B 3/10; B32B 7/04; B32B 5/16

(52) U.S. Cl. CPC B32B 3/10; B32B 5/16; B32B 7/045
USPC 428/158; 428/201

(57) ABSTRACT

A protective material/structure is provided that reduces the risk of injury for a person after contact with said material/structure, and is based on a structure where an inner and outer shell can move relative to each other. The shells are separated by spikes or thin beams and the outer shell covers or envelops the spikes. The spikes or beams are constructed so that they permit displacement of the outer shell relative to the inner shell in the event of an oblique impact against the protective material/structure. The spikes or beams are designed to be thin/slim and can be made of flexible polymer materials such as plastics, rubber or fibers. This enables the spikes to give way after a tangential/rotational impact and thereby efficiently reduce the negative effects of such an impact on the brain. The material/structure can be used in e.g. helmets, vehicle interiors, vehicle exteriors, indoor house building material, boxing gloves and the like.

### BACKGROUND OF THE INVENTION

1. Field of the Invention

The present invention relates generally to a material/structure that protects the head and body in a collision or against other types of impact. Specifically, it relates to an improved material/structure that reduces angular/rotational motion or acceleration of the human brain and body caused by an oblique impact. In the material/structure, there is an inner layer and an outer layer and a separation between the inner layer and the outer layer by spikes that are constructed so that they permit displacement of the outer layer relative to the inner layer, hereby reducing the force from an oblique impact. The material/structure can be used in e.g. helmets, vehicle interiors, vehicle exteriors, indoor house building material, boxing gloves and the like.

2. Description of the Prior Art

It can be appreciated that a material that protects e.g. the head and brain from different types of impacts can be used in several different contexts, including helmets, vehicle interiors, vehicle exteriors and boxing gloves. The brain and other organs are sensitive to an impact that results in acceleration of the organ. There are two distinct types of acceleration that can occur in an impact, linear and angular acceleration. Instances of pure angular acceleration (rotation about the center of rotation of the skull) are rare. The most common type of motion of the head is a combined linear and angular motion. Angular or rotational motion is induced by an oblique impact and is considered to cause a relatively greater damage to the brain than linear acceleration. See e.g. Ommaya, A. K. and Gennarelli, T. A., “Cerebral Concussion and Traumatic Unconsciousness: Correlations of Experimental and Clinical Observations on Blunt Head Injuries”, Brain, 97, 633-654 (1974) and Kleiven, S. “A parametric study of energy absorbing materials for head injury prevention”, Proc. ESV 2007, 20^{th} Enhanced Safety of Vehicles Conference, Lyon, France, Paper No. 07-0385-0 (2007). Examples of rotational injuries are on the one hand subdural haematomas (SDH), which are bleeding as a consequence of blood vessels rupturing, and on the other hand diffuse axonal injuries (DAI), which can be summarized as nerve fibers being injured. Depending on the characteristics of the rotational force, such as the duration, amplitude and rate of increase, either SDH or DAI occur, or a combination of these is suffered.

Different types of padding are efficient in reducing linear acceleration but the prior art contains relatively few examples of padding or shock attenuation systems intended to mitigate angular acceleration/motion. This lack of systems intended to reduce the angular acceleration is significant. In addition, the materials or systems that best manage or modulate linear forces may in many instances not best manage or modulate angular forces.

Many different arrangements are used in modern motor vehicles, such as automobiles, in order to protect the drivers, passengers and pedestrians in the event of a collision and other types of accidents. However, the prior art in the field contains relatively few examples of materials or structures intended to manage changes in angular acceleration.

In U.S. Pat. No. 6,520,568 by Holst et al., a roof structure is described that reduces the risk of serious head or neck injuries to persons travelling in a vehicle. The invention combines an impact-absorbing material with an outer layer that can be displaced somewhat relative to the inner roof structure in order to reduce the forces after an impact. The structure of the inner roof permits sliding of the outer layer in one direction (normally in the direction toward the front of the vehicle). The patent does not describe a structure that can reduce angular forces in different directions. The use of a material in cars (e.g. dashboard, inner roof, hood and bumpers) where slim projections can absorb angular forces as in the invention described herein would enable protection of the head independent of the direction of the impact.

The use of protrusions or recesses to absorb energy after an impact is known in e.g. the automobile industry. However, the invention described herein is an improved material/structure that is markedly more efficient in reducing angular forces after an impact.

In U.S. Published Patent Application No. 2002/0017805, a composite energy absorbing assembly is described. The invention combines a base structure with recesses defined within the base. The recesses may be shaped as truncated cones and these recesses have energy absorbing properties. However, the document does not describe a structure where the recesses are shaped as thin spikes/projections to absorb energy. The invention described herein results in improved protection against an angular impact when compared with designs where the ratio between the length and width of the protrusions is lower. Furthermore, the published patent application does not describe the use of slim spikes/projections that connect or are juxtaposed to two layers that can move relative to each other. In the invention described herein the projections enable protection against angular forces independent on the point of impact.

There are many examples of helmets or protective headgear intended to attenuate shock directed at the head. Helmets or protective headgear are used in many human sports and activities such as cycling, motorcycling, American football, racing, martial arts, equestrian sports, lacrosse, baseball, hockey, inline skating, skateboarding, skiing, snowboarding, kayaking and rock climbing. Protective headgear is also used in work activities such as construction, the military and fire fighting.

One strategy of reducing angular acceleration is to use two or more layers/sections that can slide relative to each other after an impact. This approach is described in U.S. Pat. No. 6,658,671. The patent describes a helmet that has an outer shell separated from the inner shell by at least one slide layer, enabling it to be moved relative to the inner shell. Coupling fittings at opposite ends of the two shells are used to absorb energy generated as a result of this relative movement, enabling the shock of a downward impact against the helmet to be effectively absorbed. This design reduces the angular forces on the brain by approximately 30-40%. Interestingly, in the invention described herein the protection is markedly improved by using thin spikes to reduce angular acceleration and this design further reduces the angular forces significantly, to approximately 50% compared to a regular helmet design where the outer shell is glued to the liner (see FIG. 9). These and subsequent comparisons were made using an advanced computer model described in U.S. application Ser. No. 12/454,538.

A somewhat similar concept is described in U.S. Pat. No. 4,307,471 of Lovell et al. In this patent, a helmet is described where the outer section is adapted to move relative to the inner section on impact with an object. In another embodiment the helmet further comprises a plurality of cushioning projections located between the two shells, each projection being integrally connected to one of the shells. The projections are substantially rigid and are designed to absorb linear (compressive) force. However, protection against angular forces or rotational acceleration is not described. Furthermore, we have compared this design with the invention described herein in the previously mentioned advanced computer model and found that our invention is at least 35% more efficient in reducing angular forces and thereby protecting the brain after an oblique impact.

In WO2006/022680 a protective headgear intended to reduce angular acceleration of the human brain after an impact is described. The headguard comprises two or more layers that permit frictional sliding of at least one area of the outer layers relative to the inner/intermediate layer. The frictional sliding can be altered by using different materials, e.g. flowable materials, fluids and gases. Furthermore, particles, films or hair-like projections (e.g. felt) can be inserted between the layers to adjust the ease with which the layers can slide in relation to each other. The construction uses connection points, called anchor points, to connect the outer layer with the inner/intermediate layer. At or near these points, no frictional sliding is permitted. Hence, the construction only enables reduction of angular forces at points located at a certain distance from the anchor points. This document does not describe a headgear that can reduce angular forces independent on the point of impact. Furthermore, the document does not describe the use of slim spikes/projections that connect or are juxtaposed to two sliding layers. In the invention described herein the projections enable protection against angular forces independent on the point of impact.

U.S. Pat. No. 6,397,399 of Lampe et al. describes a protective headgear for soccer players. In one embodiment of the invention the headgear has upraised portions of foam on the interior side of the foam. This design with foam pillows improves the capacity of the headgear to conform to the head, increases ventilation and can provide a mechanism by which torsional forces applied to the headguard and head can be absorbed and reduced. Torsional forces twist the neck and increase the likelihood of angular acceleration injuries to the brain. When a force (e.g. by a soccer ball) is directed at an angle against the external surface of the headguard, the nubbins bend.

The foam pillows of Lampe et al. are described as cylindrical upraised nubbins of foam. A diameter or width of ⅛ to ½ inches and a height of ⅛ to ½ inches for the nubbins is recommended for most applications. This bending of nubbins absorbs the force and transfers less torsional force to the head than solid foam would. Torsional forces make it harder for the soccer player to control the ball with the head. Thus, reduction in torsional forces improves the wearer's ability to control a soccer ball and protects the wearer. The patent does not describe the use of slim/thin projections or spikes to reduce angular forces. Surprisingly, the thin spikes described in the invention herein are markedly better at reducing angular forces than the cylindrical cone-like structures described in Lampe et al. (at least 17%). Furthermore, the use of foam in the upraised portions would not be suitable for applications where the forces can be high, e.g. in bicycle helmets, motorcycle helmets or vehicle interiors.

A somewhat similar concept is described in U.S. Patent Application Publication No. 2006/0059606 of Ferrara for a multilayer shell for use in the construction of protective headgear. The layers can move relative each other and the middle layer includes a plurality of compressible members, which compress and/or shear in response to an impact. The members can be shaped as columns, blobs, pyramids, cubes, rectangles or strips. The document describes the compressible members ranging from approximately ⅛ inch to 1 inch in height and ⅛ inch to ½ inch in diameter. Preferably, the members are made of thermoplastic elastomer (e.g. foam). In one embodiment the members are hollow and filled with air or fluid to regulate the compression properties.

However, the patent application does not describe the use of slim/thin projections or spikes to reduce angular forces in an impact situation. Surprisingly, the thin spikes described in the invention herein are markedly better at reducing angular forces than the structures described in Ferrara. Furthermore, the use of thermoplastic elastomer in the members would not be ideal for applications where the forces can be high, e.g. in motorcycle helmets, bicycle helmets, vehicle interiors or vehicle exteriors.

In summary, none of the prior art describes the use of slim/thin projections or spikes to reduce angular forces in an impact situation. Surprisingly, the thin spikes described in the invention herein are markedly better at reducing angular forces than the structures previously used in the prior art.

### SUMMARY OF THE INVENTION

The invention provides protective structures and methods in accordance with the appended claims.

A primary object of the present invention is to provide an improved material/structure that protects e.g. the head and brain from injury by reducing the force transmitted to the outer surface of the body in a collision/impact situation. The invention is based on a structure where an inner and outer layer are separated by spikes or thin beams. However, the invention is not limited to having only two layers. One or several intermediate layers that move relative to each other or to the inner or outer layer can also be used in the invention. The construction of the spikes permits displacement of the outer layer relative to the inner layer, hereby reducing the force from an oblique impact against e.g. the head. The outer layer covers or envelops the spikes or beams. The spikes or beams are designed to be thin/slim and can be made of flexible polymer materials such as plastics, rubber or fibers. This enables the spikes to give way after a tangential/rotational impact and thereby efficiently reduce the negative effects of such an impact on e.g. the brain.

An object of the present invention is to produce a material/structure that reduces the negative effects of an impact/collision situation.

Another object is to use the material/structure to reduce the angular or rotational acceleration in an impact/collision situation.

Another object is to use the described material/structure in helmets, or other types of headgear, in order to protect the head and brain in an impact situation.

Another object is to improve helmets in order to more efficiently protect the brain against angular or rotational acceleration.

Another object is to use the described material/structure in vehicle interiors in order to protect drivers and passengers in a collision.

Another object is to use the material/structure in vehicle exteriors in order to protect pedestrians in a collision.

Another object is to use the material/structure in boxing gloves to reduce the transmitted forces to the head after impact.

Other objects and advantages of the present invention will become obvious to the reader. For the avoidance of doubt, the description of a feature as an ‘object’ of the invention does not necessarily imply that the object is achieved by all embodiments of the invention.

There has thus been outlined, rather broadly, the more important features of the invention in order that the detailed description thereof may be better understood, and in order that the present contribution to the art may be better appreciated. There are additional features of the invention that will be described hereinafter.

### BRIEF DESCRIPTION OF THE DRAWINGS

FIG. 1 is an overview figure showing how the spikes 2 can be placed in relation to the different layers of the structure. The spikes can be placed in any location in between the outer 1 and inner layer 4 of the structure. In one design, FIG. 1c), the spikes fill the entire layer between while in other designs, FIG. 1a) and b), the spike layer has a layer of standard energy absorbing foam 3 on the inside and/or on the outside of the spike layer. In another design there is a spike layer on the inside, FIG. 1e), or the outside, FIG. 1d), of the energy absorbing foam.

FIG. 2 shows an overview figure showing how the spikes 2 can be placed in relation to the different layers of a helmet. The spikes can be placed in any location in between the outer 1 and inner shell 4 of the helmet. In one design, FIG. 2c), the spikes fill the entire layer between the outer and inner shell while in other designs, FIG. 2a) and b), the spike layer has a layer of standard energy absorbing foam 3 on the inside and/or on the outside of the spike layer. In another design there is a spike layer on the inside, FIG. 2e), or the outside, FIG. 2d), of the energy absorbing foam.

FIG. 3 illustrates the design and energy absorption behavior for the option using flexible outer shell and energy absorbing foam outside flexible spikes (e.g. for an application such as an interior impact zone in vehicles such as a dashboard in cars, buses, trains, trams, subways, airplanes etc.). Note that the material design is seen in a mid cross section. A reasonably compliant insert at the boundaries of the outer surface is needed to allow the edge of the deformable part of the panel to move during an impact. The five views show an impact sequence exemplifying how the material can behave before and during a collision between a head and the material.

FIG. 4 illustrates the design and energy absorption behavior for the option using flexible outer shell and flexible spikes (e.g. for an application such as a boxing helmet). Note that the helmet design is seen in a mid cross section. The three views show an impact sequence exemplifying how the helmet can behave before and during a collision against a hard surface (represented by brackets).

FIG. 5 shows a mid cross section illustration of the design and energy absorption behavior for a boxing glove embodiment of the invention where an outer layer is combined with relatively flexible spikes (e.g. made by a flexible polymer). The four views show an impact sequence exemplifying how the material in the glove can behave before and during the impact of a punch against a structure (represented by brackets).

FIG. 6 illustrates the design and energy absorption behavior for the option using a hard plastic outer shell and flexible spikes (e.g. for an application such as an ice hockey or bicycle helmet). Note that the helmet design is seen in a mid cross section. FIG. 6a) shows the helmet before a collision against a hard surface (represented by brackets), FIG. 6b) shows the helmet during a collision against a hard surface and FIG. 6c) is a close-up representation of FIG. 6b) showing the spikes in greater detail.

FIG. 7 illustrates the design and energy absorption behavior for the option using a relatively flexible plastic outer shell and relatively stiff plastic spikes with plasticizing or yielding inserts or ends of the spikes (e.g. for an application such as an exterior impact zone in vehicles such as a bumpers or hoods in cars, buses, trains, trams, subways etc.). Note that the material design is seen in a mid cross section. The six views show an impact sequence exemplifying how the material can behave before and during a collision between a head and the material.

FIG. 8 illustrates the design and energy absorption behavior for the option using a relatively stiff plastic outer shell and relatively stiff plastic spikes with plasticizing or yielding inserts or ends of the spikes (e.g. for an application such as motorcycle helmets). Note that the helmet design is seen in a mid cross section. FIG. 8a)-c) show an impact sequence exemplifying how the helmet can behave before and during a collision against a hard surface (represented by brackets). FIG. 8d)-f) show close-up representations corresponding to FIG. 8a)-c), showing the spikes in greater detail.

FIG. 9 shows a simulation of a 45 degree oblique impact with a velocity of 5 m/s with two different types of helmet designs where the left is the standard design having the outer shell glued to the energy absorbing foam while the design on the right uses the new design with a layer of plastic spikes between the foam and the outer shell. The striped pattern shows areas of the brain model having strains larger than 0.1 while the black pattern illustrates areas with strains lower than 0.1. Strain is defined as the change in length divided by the initial length of a material fibre. It was found that the deformation of the brain in this impact was reduced by more than 50 percent for the spike design compared to the regular helmet design. The two views show the simulation of a regular helmet design (a)) and the spike design helmet (b)).

FIG. 10 illustrates the design and energy absorption behavior for the option where inclusion of air compartments is added to or included separately (with or without spikes) using a relatively flexible plastic outer shell (e.g. for an application such as an interior impact zone in vehicles such as a dashboard in cars, buses, trains, trams, subways, airplanes etc.). Note that the material design is seen in a mid cross section. FIG. 10 shows the inclusion of the air compartments, separated by walls 6, seen in a mid cross section. It is noticeable that this fluid/air layer shears with little resistance while the fluid/air 5 at the same time distributes the pressure in the radial direction on to other parts of the structure such as the energy absorbing internal foam 3. The five views show an impact sequence exemplifying how the material can behave before and during a collision between a head and the material.

FIG. 11 illustrates the design and energy absorption behavior of a helmet for the option where inclusion of air compartments is added to or included separately (with or without spikes) using a relatively stiff plastic outer shell. Note that the helmet design is seen in a mid cross section. It is noticeable that this fluid/air layer shears with little resistance while the fluid/air 5 at the same time distributes the pressure in the radial direction on to other structures of the helmet such as the energy absorbing internal liner 3. The compartments are separated by flexible compartment-walls 6 closing in a number of spikes within each compartment. FIG. 11a) and b) show the helmet before (a)) and during (b)) a collision against a hard surface.

FIG. 12 shows examples of various designs of the spikes used in the invention as follows: a) flexible material for the spikes and their inserts that attach the spikes to the shells/layers, b) stiff material for the spikes in combination with a hinge type of inserts, c) hard plastic spikes with plasticizing, yielding or frangible inserts with different designs of the inserts having a more narrow cross section in a small part of the length exemplified in a close-up, and d)-f) every other spike is attached only to the inner or outer shell using either: d) a flexible material for the spikes and the inserts, e) stiff material for the spikes in combination with a hinge type of inserts, f) hard plastic spikes with plasticizing, yielding or frangible inserts.

### DETAILED DESCRIPTION OF THE INVENTION AND PREFERRED EMBODIMENTS THEREOF

As used herein a “flexible” material includes reference to a material that returns to its original shape after the stress or external forces that made it deform is removed and which is capable of deforming easily without breaking.

As used herein the term “plasticizing” includes reference to a material undergoing non-reversible changes of shape in response to applied forces and which is capable of undergoing continuous deformation without rupture or relaxation.

As used herein the term “yielding” limit is defined as the stress at which a material begins to deform plastically or when it begins plasticizing.

If the natural form or shape of an object is changed by exceeding the plasticity or yielding limit of the material, it is referred to be “pre-deformed”.

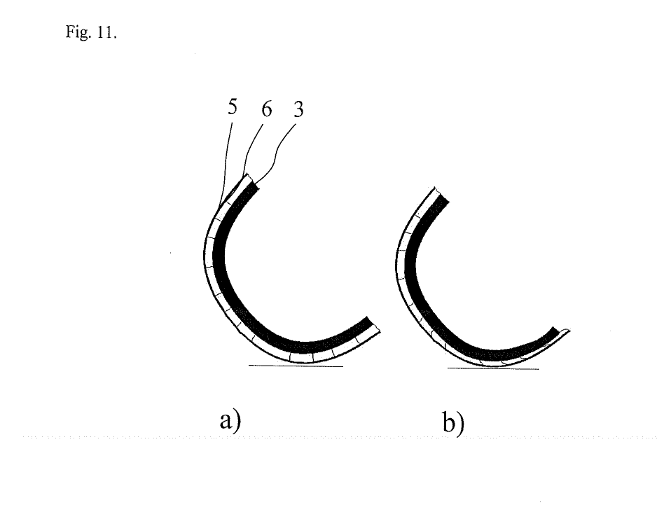

As used herein the term “initialized waist” is intended to mean when the cross-section is narrowed at some place along the length direction of the spikes/beams such as seen in FIG. 11c).

The term ‘fluid’ is understood to include reference to both gases and liquids.

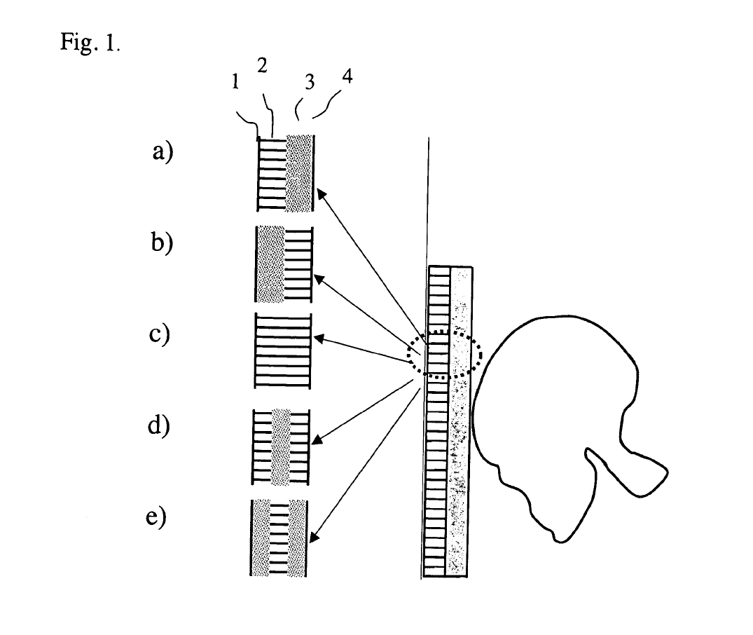

The present invention includes the production and use of an improved material/structure that reduces the risk of injury following a collision/impact. The material protects the head and brain from injury by reducing the force transmitted to the outer surface of the head in a collision/impact situation. The invention is based on a structure where an inner and outer layer can move relative to each other. However, the invention is not limited to having only two layers. One or several intermediate layers that move relative to each other or to the inner or outer layer can also be used in the invention. Two, or more, of the shells (layers) are separated by spikes or thin beams, which are so constructed that they are either flexible, plasticizing, yielding or frangible in order to absorb/reduce the force of an impact towards the material. This reduction or absorption of the force of an impact results in a protection of the head and brain. On the outside of the spikes is a shell that covers or envelops the spikes. This covering shell is preferably the outer shell, but the spikes can be placed between any of the layers in the structure. The spikes can be placed in any localization in between the outer and inner shell of the material. In one design (FIG. 1c), the spikes fill the entire length between the outer and inner shell while in other designs (illustrated in FIG. 1a) and b)), the spike layer has a layer of standard energy absorbing foam on the inside and/or on the outside of the spike layer. In this design, the thickness of the energy absorbing foam is preferably in the range of 0.1 to 10 times the thickness of the spike layer. If an energy absorbing foam liner is used, the spike layers can be glued or otherwise fitted on the inside or outside this energy absorbing foam liner while the outer shell can be glued or otherwise fitted on the outermost layer whether this is a layer of spikes or an energy absorbing foam liner. The energy absorbing foam liner can be made of different material including but not limited to vinyl nitrile, polyurethane, expanded polystyrene and expanded polypropylene.

The spikes or beams are designed to be thin/slim, having a ratio between length and thickness/diameter generally higher than approximately 3/1, and can be made of flexible or stiff polymer materials or other materials with these properties such as plastics, rubber, metals, alloys, ceramics or fibers. There are many different ways to form polymers, alloys or metals by extrusion, casting, etc. and the most cost-effective solution depends on the choice of material and design. For a structure involving different materials for the spikes and the inserts; these components can be molded or cast separately and put together later on during the assembly process. The harder spikes can be tight fitted, glued onto or otherwise fitted to the softer and/or yielding insert material during assembly.

Preferably, the ratio between the length and thickness/diameter of the spikes ranges between 4/1 and 100/1. More preferably, the ratio between the length and thickness/diameter of the spikes ranges between 5/1 and 40/1. Even more preferably, the ratio between the length and thickness/diameter of the spikes ranges between 6/1 and 30/1. Most preferably, the ratio between the length and thickness/diameter of the spikes ranges between 9/1 and 20/1.

The ratio between the length and the thickness or diameter of the spikes or thin beams may be greater than 9/1.

The ratio between the length and thickness or diameter of the spikes or thin beams may be greater than 12/1.

The ratio between the length and the thickness or diameter of the spikes or thin beams may range between 9/1 and 1000/1, preferably between 9/1 and 100/1, more preferably between 9/1 and 40/1.

The ratio between the length and the thickness or diameter of the spikes or thin beams may range between 12/1 and 1000/1, preferably between 12/1 and 100/1, more preferably between 12/1 and 40/1.

The distance between the spikes can generally range from being approximately the diameter of the spikes to about the length of the spikes. Preferably this distance ranges between 2 and 40 spike diameters/thicknesses. However, the distance can be optimized depending on the choice of the material, geometry and attachment of the spikes.

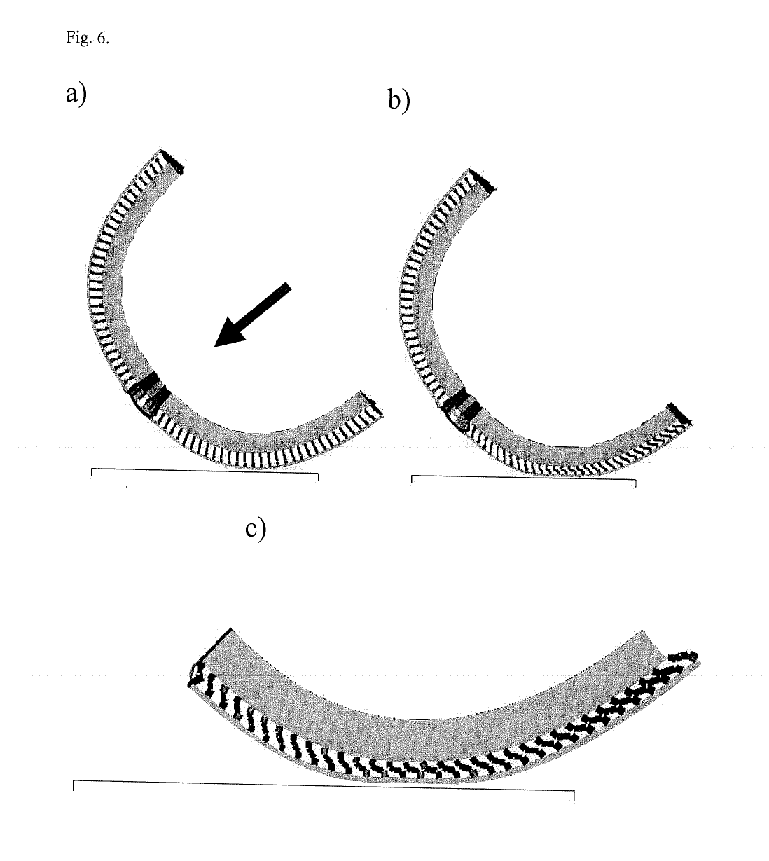

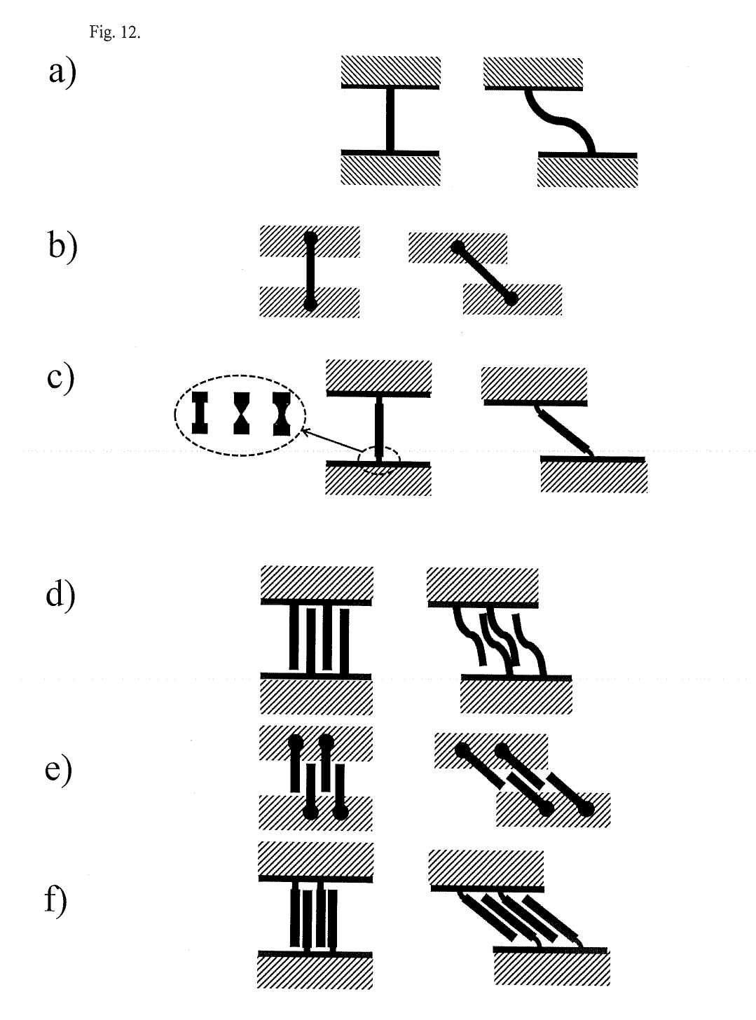

For an ice hockey helmet, boxing helmet or other types of helmets designed for repetitive impacts, generally a choice of a relatively flexible material (including, but not limited to, soft plastic materials, rubbers, fabric or various types of polymers having a relatively low stiffness) for the spikes as depicted in FIG. 12a) would be preferred so that the system can deform back to the undeformed condition after the impact (FIG. 6). There are many different ways to form the spikes for the different polymers, for example, by extrusion, casting, etc. and the most cost-effective solution depends on the choice of material, the helmet design and the size of the production series.

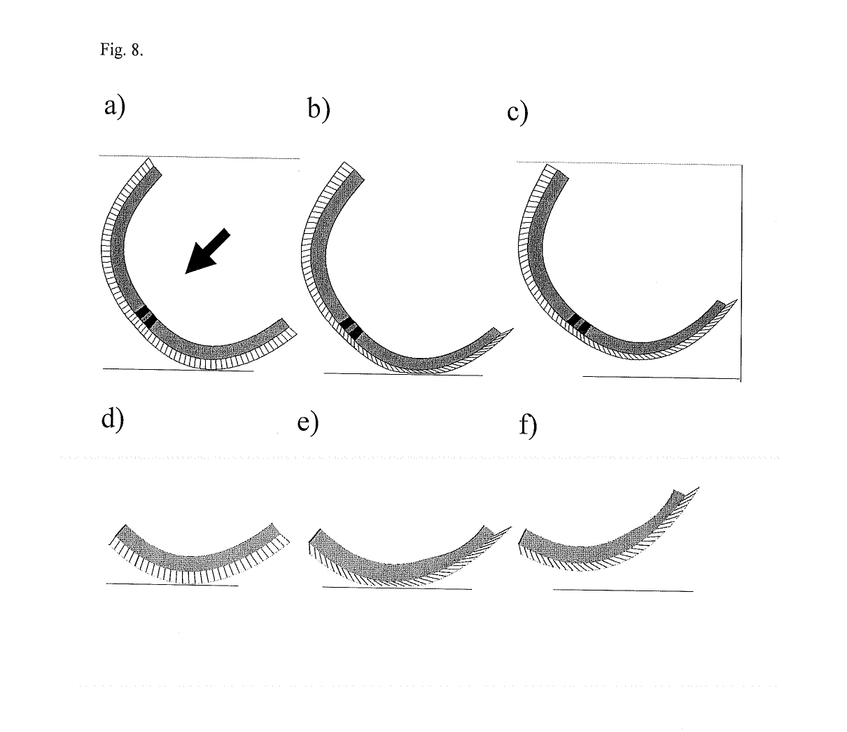

For a motorcycle helmet or other types of helmets (FIG. 8) having a hard plastic type of outer shell, thin and plasticizing, yielding or frangible spikes as shown in FIG. 12c) with approximately 0.25-2.0 mm diameter and acrylonitrile butadiene styrene (ABS) hard plastic type of material properties in the range of 0.1-10 GPa Young's modulus or yielding inserts fixing the spikes to the shells/layers would be preferred. However, the spikes for a motorcycle helmet can be made of different materials including but not limited to hard plastic materials, thermoplastic materials (e.g. ABS), soft metals, fabric, and various types of polymers or polymer composites having a relatively high stiffness. In some designs the inserts could be manufactured to be frangible having a narrow cross section in a small part of the length as shown in FIG. 12c). Hard plastic helmet outer shells are preferably made from a polymer composite material or a thermoplastic material (e.g. ABS). The outer shell and the spike layers can be made of the same hard plastic material to simplify the manufacturing process, but different material can also be used for the different components.

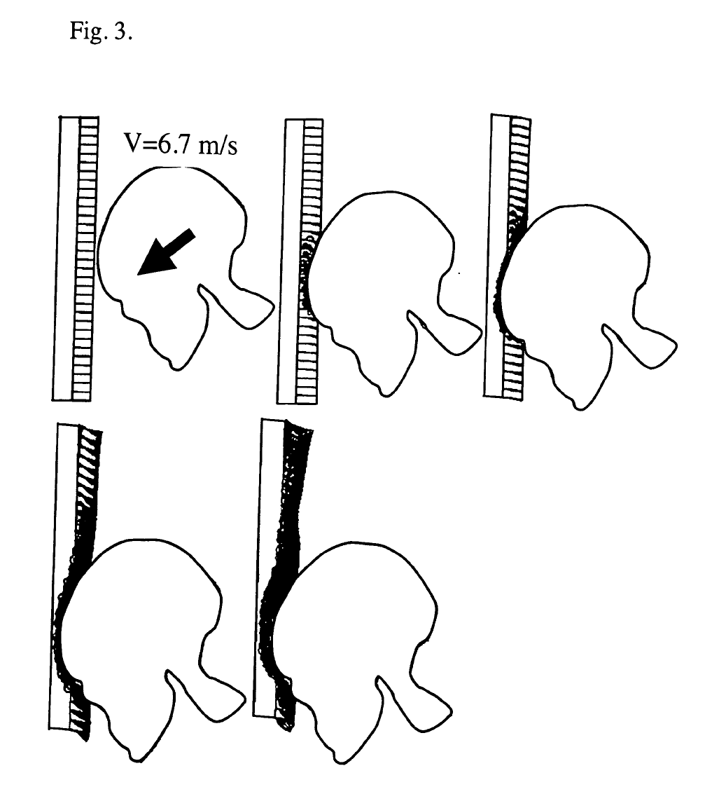

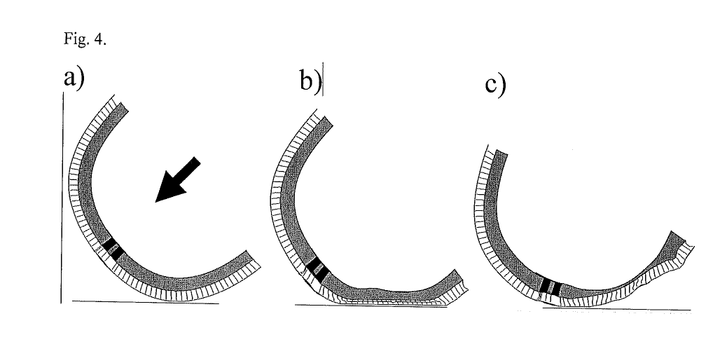

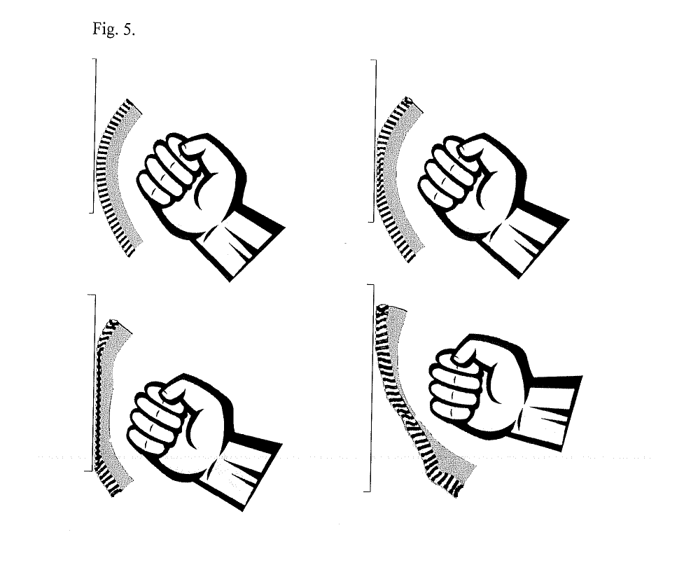

For boxing gloves (FIG. 5), or other types of panels/structures designed for repetitive impacts (FIG. 3-4), generally a choice of a relatively flexible polymer material for the spikes (as depicted in FIG. 12a) would be preferred so that the system can deform back to the undeformed condition after the cushioned impact. These materials include, but are not limited to, soft plastic materials, rubbers, fabric or various types of polymers having a relatively low stiffness. In some designs the inserts could be manufactured to be frangible having a narrow cross section in a small part of the length as shown in FIG. 12c).

In addition, devices to measure the severity of the blow can be included in the spike layers in a boxing glove, said devices measuring relative velocity and forces in the spikes in order to register and/or quantify the impact of a punch. In order to measure the pressure within the boxing gloves a pressure sensitive film or other pressure-registering components can be used. The film or other pressure-registering component can be placed in any layer of the gloves but preferably on the inner shell or on the innermost layer of the material described herein. One example of a manufacturer and brand of pressure sensitive films is TEKSCAN®. The film can consist of a number of pressure sensitive sensors distributed on a thin plastic film. Each sensor can be located throughout the film and can send their value of absolute pressure in real time. This signal can be sent by e.g. a miniature radio transmitter and received, processed and visualized at e.g. a nearby personal computer. The range of which pressure should be measured for this film will be adjusted to levels representative to expected hits of different severities. In this way the severity of the hits can be recorded and counted in e.g. amateur boxing bouts instead of the manual system used today.

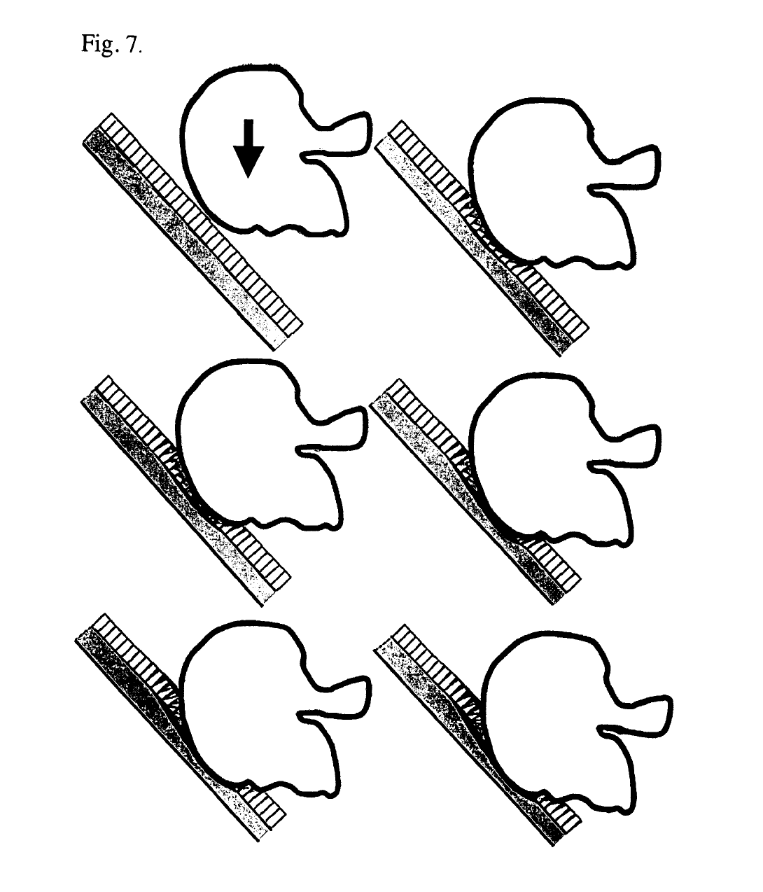

For a structure designed to tolerate one major impact such as during a traffic accident (FIG. 7) having a flexible plastic type of outer shell, thin and plasticizing, yielding or frangible spikes (FIG. 12c) with approximately 0.25-2.0 mm diameter and acrylonitrile butadiene styrene (ABS) hard plastic type of material properties in the range of 0.1-10 GPa Young's modulus or yielding inserts fixing the spikes to the shells/layers would be preferred. However, other dimensions of the spikes can also be used for this type of application. Other materials for the spikes of an interior or exterior impact panel of a vehicle include, but are not limited to, different hard plastic materials, thermoplastic materials (e.g. ABS), soft metals, fabric and various types of polymers or polymer composites having a relatively high stiffness. The outer shell and the spike layers can be made of the same hard plastic material to simplify the manufacturing process, but different materials can also be used for the different components.

The spikes or beams can be attached in different ways to the shells/layers depending on the magnitude and type of impact that the material is intended to protect from. The yielding inserts that could be used for fixing the spikes to the shells/layers of the invention could be made up of a plasticizing foam or plastic material in the inserts or a pre-deformed or initialized waist of the spike ends as shown in FIG. 12c). An alternative using stiff material for the spikes would be a hinge type of insert where the spikes can shear due to an oblique impact with relatively low resistance while having a high resistance in the radial direction (in the longitudinal direction of the spikes) as depicted in FIG. 12b). A fixation where every other spike is attached only to the inner or outer shell is seen in FIG. 12d)-f). This solution has the advantage of absorbing additional energy during an oblique impact by friction and interaction between the spikes.

The design of the material/structure and the outer and inner layers enables the spikes to give way more easily after a tangential/rotational impact and thereby efficiently reduce the negative effects of such an impact on the organs of the human body such as the brain. The spikes or beams are so constructed and connected to the shells that they permit displacement of the outer shell relative to the inner shell in the event of an oblique impact against the protective material. By virtue of the fact that the outer shell of the structure can be displaced relative to the inner shell, through shearing and bending of the spikes/beams, during simultaneous absorption of rotational energy in the material, it is possible to reduce the injurious forces, with a reduced risk of injury as a consequence.

When the material is used in e.g. helmets using different materials for the spikes and the inserts, these components can also be molded or cast separately and put together later on during the assembly process. The harder spikes can be tight fitted, glued onto or otherwise fitted to the softer and yielding insert material during assembly.

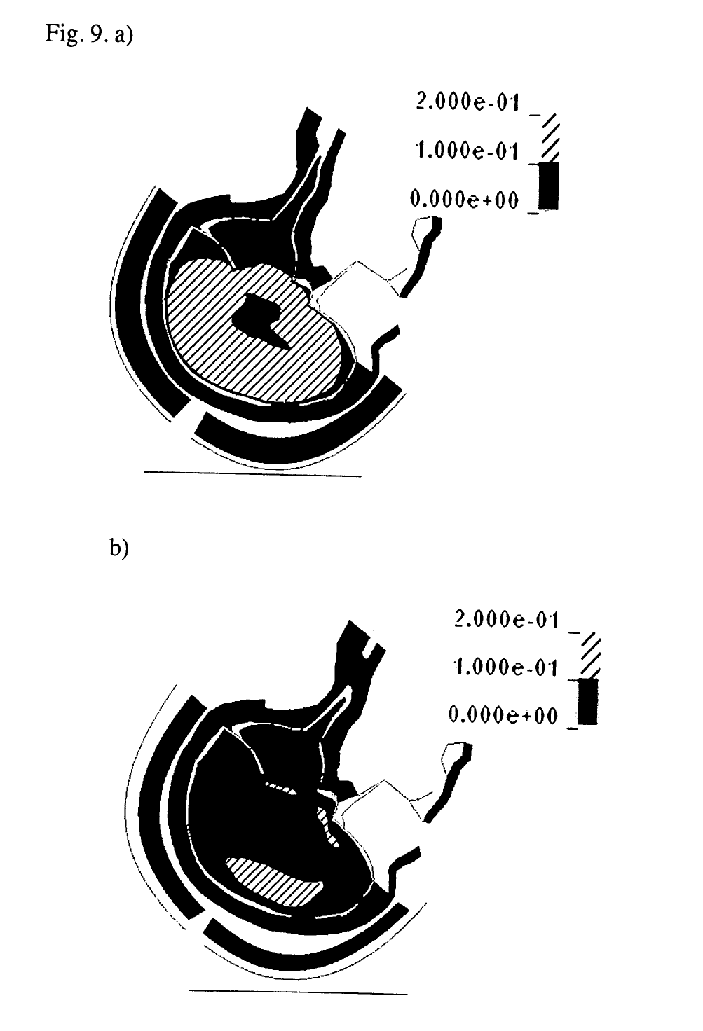

It can be seen that the introduction of thin spikes significantly reduced the deformation of the brain during a realistic oblique impact (FIG. 9). For this choice of material (0.5 mm diameter and 10 mm length of the spikes and ABS plastic properties) where the spikes can plasticize at the junctions with the liner and outer shell, the reduction of the strain in the brain is more than 50%.

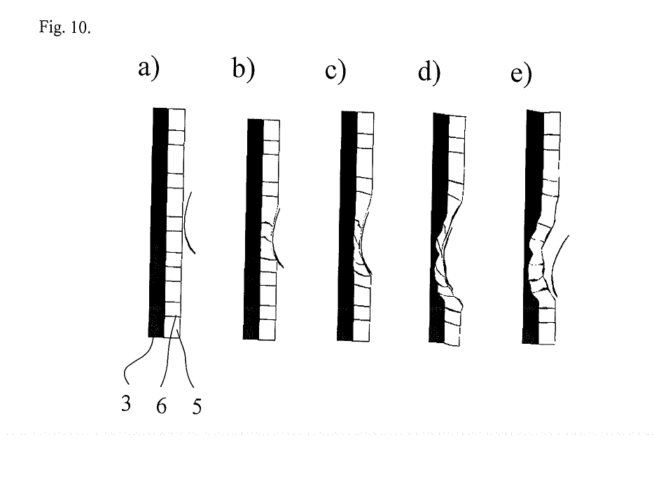

The spikes can be complemented by trapped fluid such as air in different compartments as seen in FIG. 10 (material/structure) and FIG. 11 (helmet). The combination of the spikes that keep the outer and inner shells apart and the air that gives compression resistance and deforms with little resistance in the tangential direction is different to previous inventions and results in effective protection. The air/fluid can also be allowed to flow through small channels between the compartments for certain applications. Furthermore, the material/structure described herein (used in e.g. a helmet) can be made of different sections, with or without trapped air in the sections/compartments, between which ventilation holes may be placed.

Another possible way of improving the protection (especially against linear acceleration) is to combine the spikes with different shock-absorbing materials (e.g. foam). This combination of the spikes with a shock-absorbing material is illustrated in FIG. 1. The energy absorbing foam can be made of e.g. vinyl nitrile, polyurethane, expanded polystyrene or expanded polypropylene. The spikes can be placed in any localization in between the outer and inner shell of the material. In one design shown in FIG. 1c), the spikes fill the entire length between the outer and inner shell while in other designs illustrated in FIG. 1a) and b), the spike layer has a layer of standard energy absorbing foam on the inside and/or on the outside of the spike layer. In another design there is a spike layer on the inside, FIG. 1e), or the outside, FIG. 1d), of the energy absorbing foam. In this design, the thickness of the energy absorbing foam is preferably in the range of 0.1 to 10 times the thickness of the spike layer. If an energy absorbing foam liner is used together with the material/structure the spike layers can be glued or otherwise fitted on the inside or outside of this energy absorbing foam liner while the outer shell can be glued or otherwise fitted on the outermost layer whether this is a layer of spikes or an energy absorbing foam liner. The energy absorbing foam liner can be made of different materials including but not limited to vinyl nitrile, polyurethane, expanded polystyrene, expanded polypropylene and other materials commonly used in e.g. helmets designed for repetitive impacts (e.g. ice hockey helmets). Furthermore, the spikes can be fully integrated in a shock-absorbing material so that the spikes are surrounded by said material.

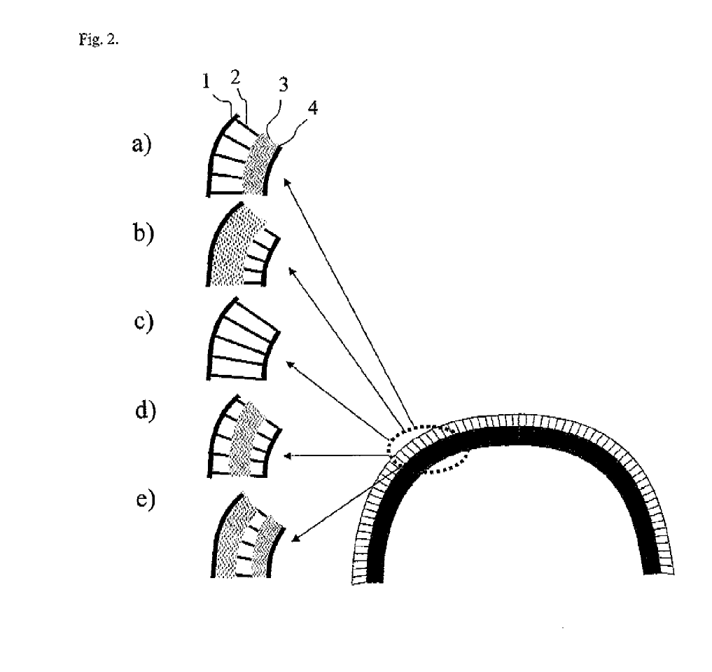

In FIG. 2, the previously described ways of improving the protection (especially against linear acceleration) by combining the spikes with different shock-absorbing materials (e.g. foam) is schematically described for a helmet. The energy absorbing foam can be made of e.g. vinyl nitrile, polyurethane, expanded polystyrene or expanded polypropylene. The spikes can be placed in any localization in between the outer and inner shell of the material. In one design shown in FIG. 2c), the spikes fill the entire length between the outer and inner shell while in other designs illustrated in FIG. 2a) and b), the spike layer has a layer of standard energy absorbing foam on the inside and/or on the outside of the spike layer. In another design there is a spike layer on the inside, FIG. 2e), or the outside, FIG. 2d), of the energy absorbing foam. In this design, the thickness of the energy absorbing foam is preferably in the range of 0.1 to 10 times the thickness of the spike layer. If an energy absorbing foam liner is used together with the material/structure, in helmets, the spike layers can be glued or otherwise fitted on the inside or outside of this energy absorbing foam liner while the outer shell can be glued or otherwise fitted on the outermost layer whether this is a layer of spikes or an energy absorbing foam liner. The energy absorbing foam liner can be made of different materials including but not limited to vinyl nitrile, polyurethane, expanded polystyrene, expanded polypropylene and other materials commonly used in e.g. helmets designed for repetitive impacts (e.g. ice hockey helmets). Furthermore, the spikes can be fully integrated in a shock-absorbing material so that the spikes are surrounded by said material.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### EXAMPLE 1

For a structure designed with flexible spikes having a soft plastic outer shell, the outer shell, the spike layers including the inserts are casted in one piece using the same soft polymer material (silicone rubber, Dow Corning, Midland, Mich.). After casting compartment walls are included in the process so that a number of spikes are constrained within their own compartment of air, consequently producing a complete module.

### EXAMPLE 2

For a structure designed with spikes having a hard plastic outer shell, the spike layers including the inserts are casted in one piece using silicone rubber (Dow Corning, Midland, Mich.). During casting, compartment walls are included in the process so that a number of spikes are constrained within their own compartment of air. The hard plastic outer shell is casted using acrylonitrile butadiene styrene (ABS, Trident Plastics Inc. Ivyland Pa.). The spike layer module is covered with a layer of expanded polypropylene (ARPRO®, JSP, Madison Heights, Mich.) and the resulting structure is glued to the hard plastic outer shell.

### EXAMPLE 3

For a helmet designed with flexible spikes having a soft plastic outer shell, the outer shell and the spike layers including the inserts are cast in one piece using the same soft polymer material (silicone rubber, Dow Corning, Midland, Mich.). The spikes in the helmet are 10 mm long, have a diameter of 2 mm and are placed 6 mm from each other. After casting, compartment walls are included in the process so that a number of spikes are constrained within their own compartment of air. In this way a complete module is produced and the outer and inner shells together are coupled with an internal layer of energy absorbing foam liner made by expanded polypropylene (ARPRO®, JSP, Madison Heights, Mich.).

### EXAMPLE 4

For a helmet designed with flexible spikes having a hard plastic outer shell, the spike layers including the inserts are casted in one piece using silicone rubber (Dow Corning, Midland, Mich.). The spikes in the helmet are 12 mm long, have a diameter of 1 mm and are placed 4 mm from each other. During casting, compartment walls are included in the process so that a number of spikes are constrained within their own compartment of air. The hard plastic outer shell is casted using the thermoplastic material acrylonitrile butadiene styrene (ABS, Trident Plastics Inc. Ivyland Pa.). The spike layer module is covered with a layer of expanded polypropylene (ARPRO®, JSP, Madison Heights, Mich.) and the resulting structure is glued to the hard plastic outer shell.

### EXAMPLE 5

Similar to the method described in Example 3 a motorcycle helmet is produced by casting the whole module in one piece using ABS (Trident Plastics Inc. Ivyland Pa.). In this way a complete module is produced and the outer and inner shells together are coupled with an internal layer of energy absorbing foam liner made by expanded polypropylene (ARPRO®, JSP, Madison Heights, Mich.). The inserts are manufactured to be frangible having a narrow cross section in a small part of the length as shown in FIG. 12c). The spikes in the helmet are 8 mm long, have a diameter of 1 mm and are placed 2 mm from each other.

### EXAMPLE 6

Similar to the method described in Example 1, a boxing glove is produced by casting the whole module in one piece using silicone rubber (Dow Corning, Midland, Mich.). During casting, compartment walls are included in the process so that a number of spikes are constrained within their own compartment of air. In this way a complete module is produced. The spikes in the boxing glove are 15 mm long, have a diameter of 1.5 mm and are placed 8 mm from each other.

### EXAMPLE 7

The material applied on boxing gloves (see Example 6 for how to make a boxing glove using the present invention) significantly reduces the tangential forces transferred from the fist to the human head or other parts of the human body during a hit. The material shears during the force transfer and a reduced rotational force is transferred to the human body part enduring the impact. In this way the severity of the hit is reduced and potentially injurious blows result in markedly reduced negative effects for the opponent. Instead, devices to measure the severity of the blow are included in the spike layers by measuring relative velocity and forces in the spikes. In order to measure the pressure within the boxing gloves a pressure sensitive film is used (TEKSCAN®, South Boston, Mass.). The film is placed on the innermost layer of the material. The film has a number of pressure sensitive sensors distributed on the thin plastic film. Each sensor is located throughout the film and sends its respective value of absolute pressure in real time. This signal is sent by a miniature radio transmitter and received, processed and visualized at a nearby personal computer. The range of which pressure is measured for this film is adjusted to levels representative to expected hits of different severities. In this way the severity of the hits is recorded and counted in e.g. amateur boxing bouts instead of the manual system used today.

### EXAMPLE 8

Similar to the method described in Example 1, a dashboard of a vehicle is produced by casting the whole module in one piece using a hard plastic material (Acrylonitrile butadiene styrene (ABS), Trident Plastics Inc. Ivyland Pennsylvania). The spikes in the dashboard are 10 mm long, have a diameter of 2 mm and are placed 4 mm from each other. The spike inserts are manufactured to be frangible having a narrow cross section in a small part of the length as in FIG. 12c).

### EXAMPLE 9

Similar to the method described in Example 8 an exterior impact panel of a vehicle is produced by casting the whole module in one piece using a hard plastic material (Acrylonitrile butadiene styrene (ABS), Trident Plastics Inc. Ivyland Pa.). The spikes in this exterior impact panel are 25 mm long, have a diameter of 1.5 mm and are placed 15 mm from each other. The spike inserts are manufactured to be frangible having a narrow cross section in a small part of the length as in FIG. 12c).

1. A protective structure for protecting a head or body in a collision or other type of impact, the protective structure including an inner layer and an outer layer which are separated by spikes or thin beams, wherein the ratio between the length and the thickness or diameter of the spikes or thin beams is greater than about 3/1, such that the spikes or thin beams permit displacement of the outer layer relative to the inner layer and thus reduction of angular motion or acceleration of the head or body thereby reducing the force imparted from an oblique impact to the head or body.

2.-7. (canceled)

8. A protective structure according to claim 1, in which the distance between the spikes or thin beams ranges from approximately the thickness or diameter of the spikes or thin beams to about the length of the spikes or thin beams.

9. (canceled)

10. A protective structure according to claim 1 including a first subset of spikes or thin beams which are attached only to the inner layer, and a second subset of spikes or thin beams which are attached only to the outer layer.

11. A protective structure according to claim 1, in which the spikes or thin beams are attached to at least one of the inner and outer layers via an insert.

12.-14. (canceled)

15. A protective structure according to claim 1, in which the insert is a hinge.

16.-19. (canceled)

20. A protective structure according to claim 1 further including at least one foam layer disposed between the inner and outer layers.

21.-24. (canceled)

25. A protective structure claim 1, in which the outer layer is flexible.

26. A protective structure according to claim 1, in which the outer layer is stiff or hard.

27.-29. (canceled)

30. A protective structure according to any preceding claim 1, further including a plurality of compartments containing a fluid such as air, the compartments being located between a pair of layers of the protective structure.

31.-45. (canceled)
